(19) United States
(12) Patent Application Publication
(10) Pub. No.: US 2003/0123939 A1
(43) Pub. Date: Jul. 3, 2003

(54) Apparatus and method of dice manufacture

(76) Inventor: Guy Gardner, Sparks, NV (US)

Correspondence Address: Brian C. Kelly, Hawkins, Folsom & Muir, Suite 416, One East Liberty St., Reno, NV, 89501, US

(21) Appl. No.: 10/034,614

(22) Filed: Dec. 28, 2001

(51) Int. Cl. B23B 35/00

(52) U.S. Cl. 408/1 R; 408/42; 408/56; 408/70

(57) ABSTRACT

A method and apparatus for dice manufacture including robotic manipulation of a work piece to obviate manual handling and reduce risk of worker injury.

### BACKGROUND-FIELD OF INVENTION

This invention relates generally to the field of dice manufacture.

### DESCRIPTION OF THE PRIOR ART

Dice have been manufactured by hand drilling using jigs for years. The fact that dice require a precise layout and depth of hole for manufacture has been a limitation on the implementation of robotics in manufacture. The Applicant has made improvements to the dice manufacture art which make the manufacture faster and more precise, but more importantly by removing the operator's hands from contact with such a small work piece the Applicant has made the operator significantly safer.

### SUMMARY & OBJECTS OF THE INVENTION

A first object of the invention is to automate the step of orienting the workpiece in the manufacture of dice.

A second object of the invention is to speed up the production capacity of dice manufacture.

### BRIEF DESCRIPTION OF DRAWINGS

FIG. 1 is a front perspective view of machine and controls.

FIG. 2 is a is a rear perspective view of machine.

FIG. 3 is a side perspective view of machine.

FIG. 4 is an opposite side perspective view of machine.

FIG. 5A is a perspective view of untouched work piece.

FIG. 5B is a perspective view of first operation work piece.

FIG. 5C is a perspective view of second operation work piece.

FIG. 6 is a front perspective view of machine.

FIG. 7 shows a work piece loaded into clamp position.

FIG. 8 shows the work piece moved to the drilling location and the movement of precision drill motors.

FIG. 9 shows the once-drilled work piece moved back for evacuation and reorientation by an air blast.

FIG. 10 shows the operation of the reorientation track.

FIG. 11 shows the reoriented work piece clamped into position for being moved into the drilling position.

FIG. 12 shows the drills working on a work piece.

FIG. 13 shows the egress function where a drilled work piece is urged onto an egress track by a blast of air.

FIG. 14 shows the drilling scheme for the drill elements.

### DESCRIPTION OF PREFERRED EMBODIMENT

FIG. 1 shows a work station. A table 1 supports a computer control represented by a screen 2 and key board 3. While computer developments are certainly contemplated by this invention, The computer is used to control the movement and timing of certain servo motors and future computers will be able to do this perhaps increasingly faster but in substantially the same way. The computer's storage and CPU facility are in structure 4.

The machine 5 uses pneumatic actuation provided by pneumatic feed lines 6. The work pieces 7 are placed in a column tube 8 in which gravity feeds them to a bottom aperture 9. This column is replaced in another embodiment by a box 10 with an angled floor 11 which can be filled helter skelter and will allow the work pieces to funnel down to a column similar to column 8. In another embodiment the columns 8 are interchangeable by an operator. The box may have to be shaken to assure piece flow through. The work pieces exit on ramp 12.

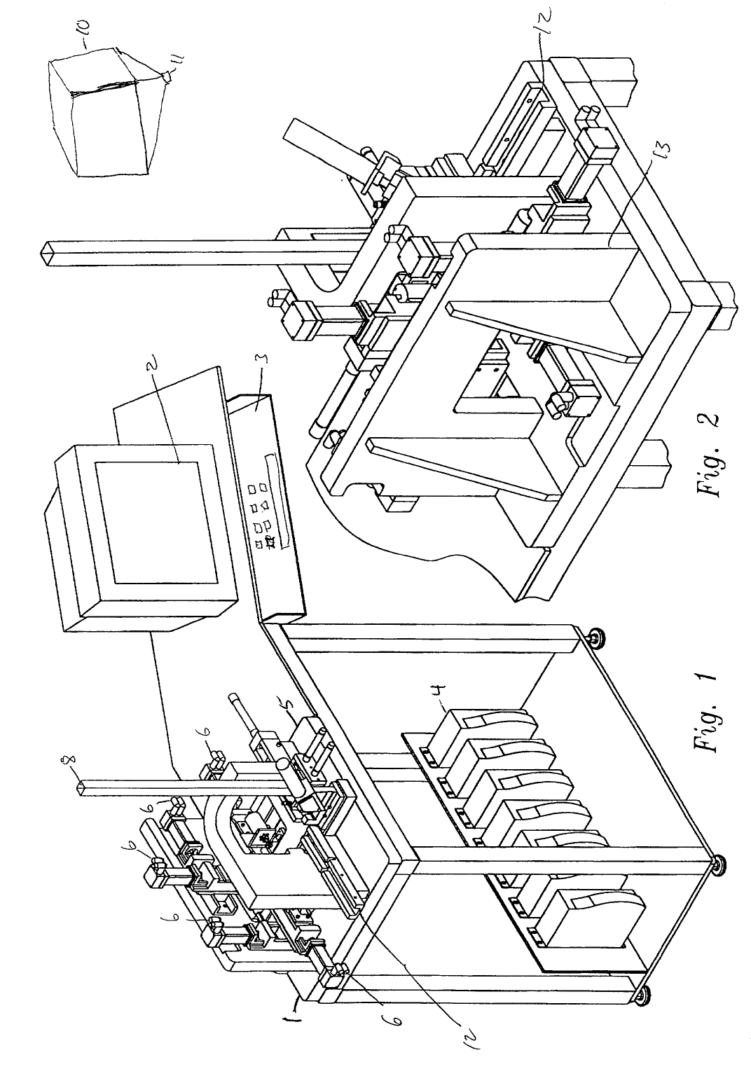

FIG. 2 shows support wall 13. This provides a rigid support for the drill motors 14 and their positioning motors 15.

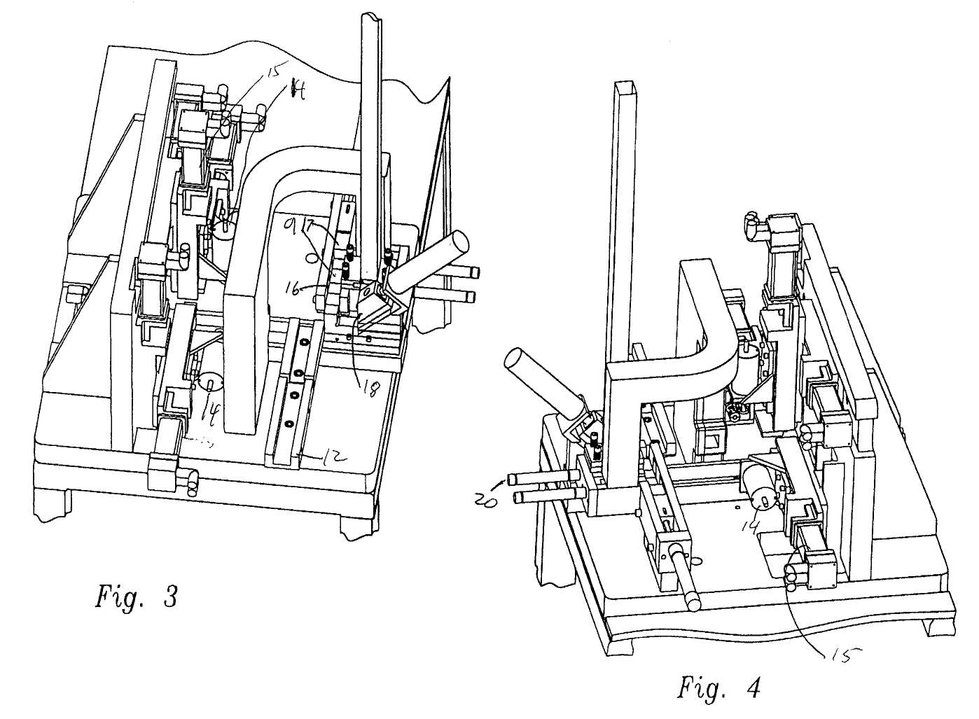

FIG. 3 shows a view along the exit ramp 12. A work piece 7 exits the column 8 into the introduction ramp 16. It is then pushed by a motor-driven ram 17 to the clamp 18. The clamp haws secure the work piece and the clamp assembly travels to the drilling area 19. There a top drill and two opposing side drills drill a pattern of holes in their corresponding side of the work piece. FIG. 4 shows a view from the ram 17 side.

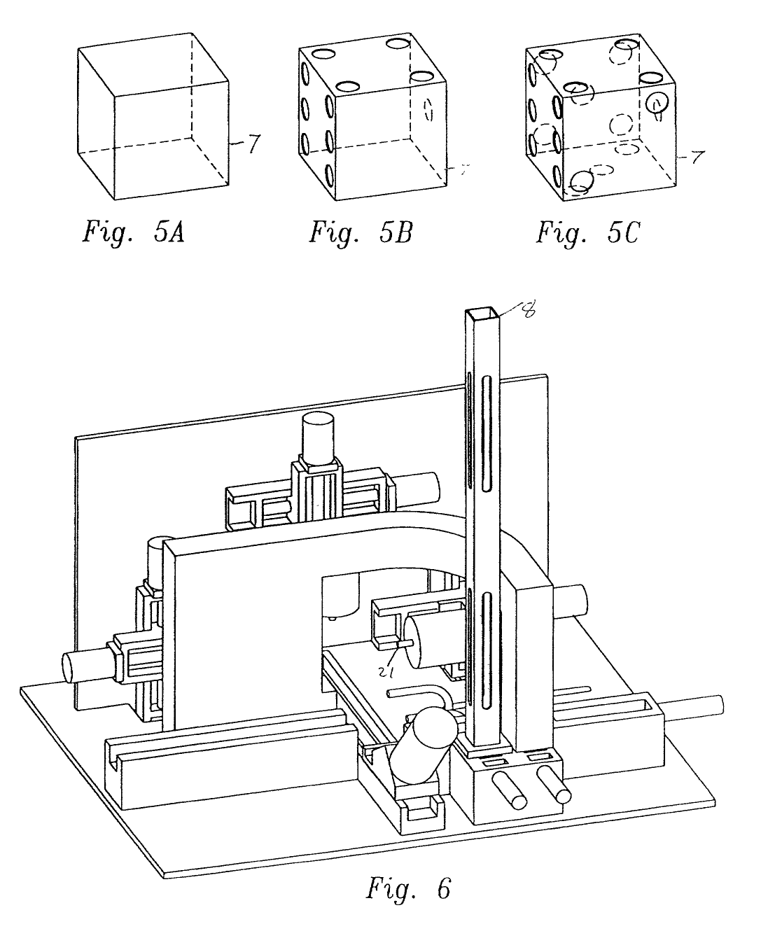

FIGS. 5A-C shows a work piece in its three degrees of work for this machine. After these steps are the step of filling the holes and machining them to final tolerances. FIG. 5A shows a work piece ready for the clamp 18.

FIG. 5B shows a work piece worked from the top and two sides. This first process could just as easily have been programmed to be the 2, 3, and 5, rather than the 1, 4, and 6 as shown. The invention also contemplates other orientations of the numbers; however, the shown orientation is most common as the numbers that sum to seven are opposite each other.

FIG. 5C shows a work piece drilled from all sides. The holes are uniform depth.

FIG. 6 shows air tubes 20 used for urging the work piece first up the orientation changing machine and second to the exit ramp. FIG. 6 also shows the drill bodies 21 used to drill the holes. They are held on two axes of movement toward the work piece and away as well as side-to-side over the work piece.

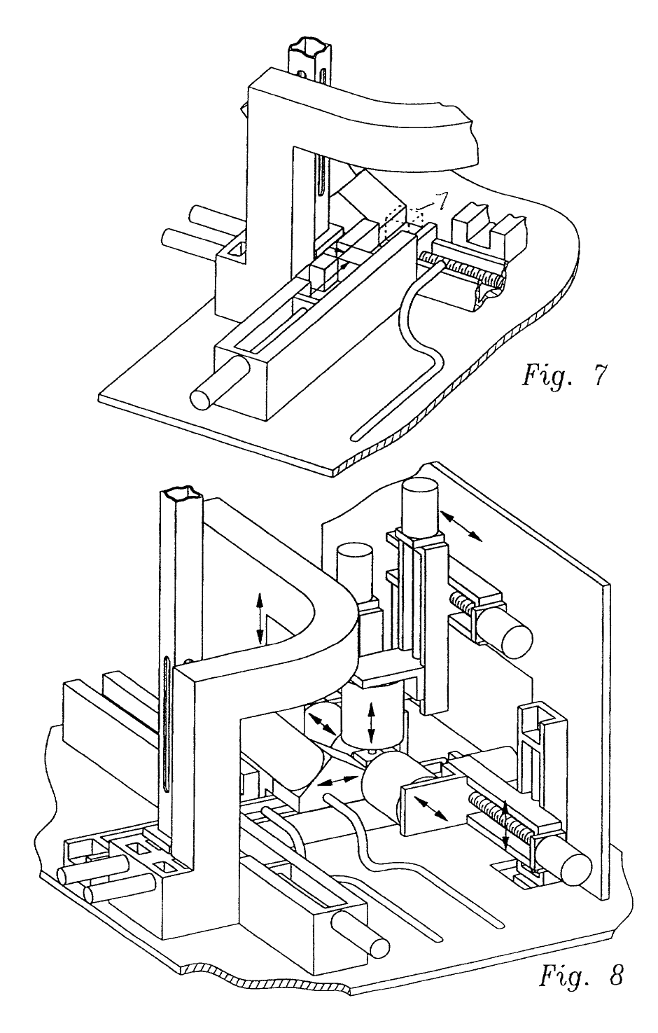

FIG. 7 shows the work piece 7 pushed from the column 8 and maneuvered into clamping position. The linear actuator for the clamp assembly is shown in its extended position. FIG. 8 shows the clamp assembly retracted into the drilling position where the drill bodies can move over the work piece to work it as shown in FIG. 5B.

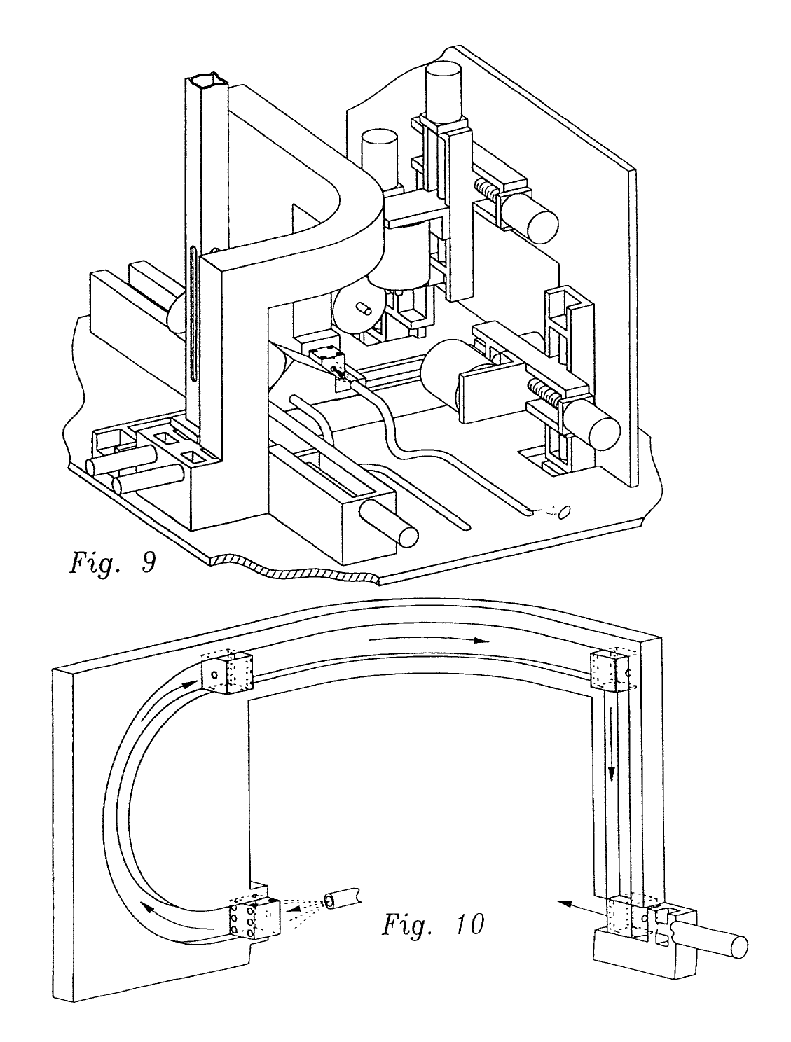

In FIG. 9 the drill bodies retract and the clamp assembly extends to align the partially prepared work piece with the reorientation mechanism. The work piece is urged by an air blast through the reorientation mechanism. The reorientation is shown in FIG. 10. It is rotated 180° vertically and then spun 90° so that the three unworked surfaces are on the top and two sides.

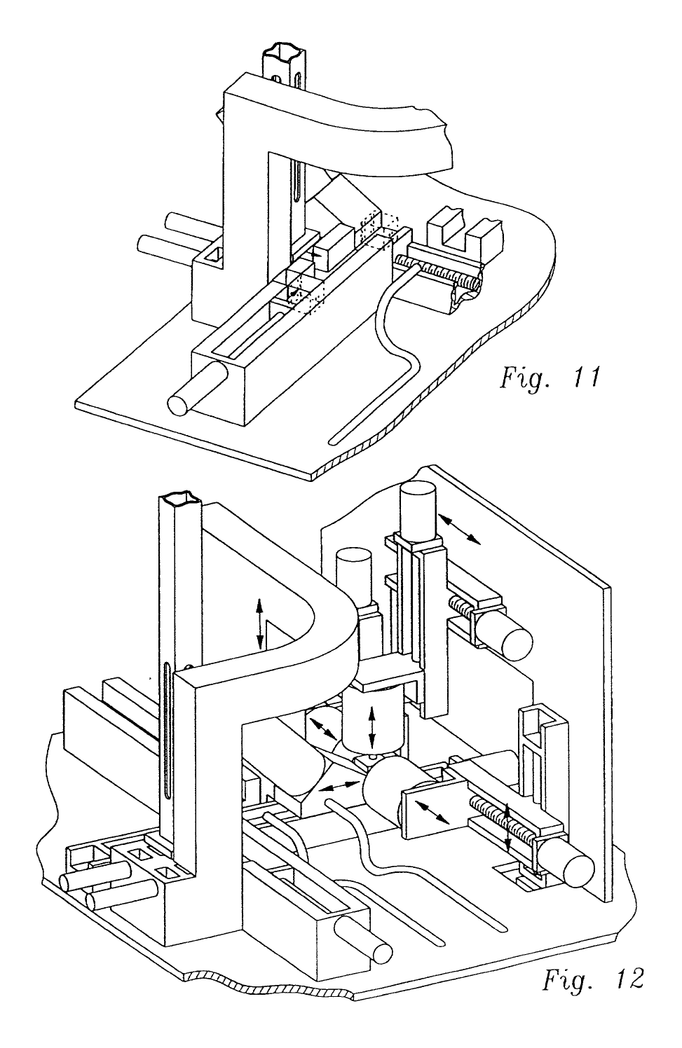

FIG. 11 shows the partially worked work piece 7 fed into the feed ramp and maneuvered to the clamping assembly.

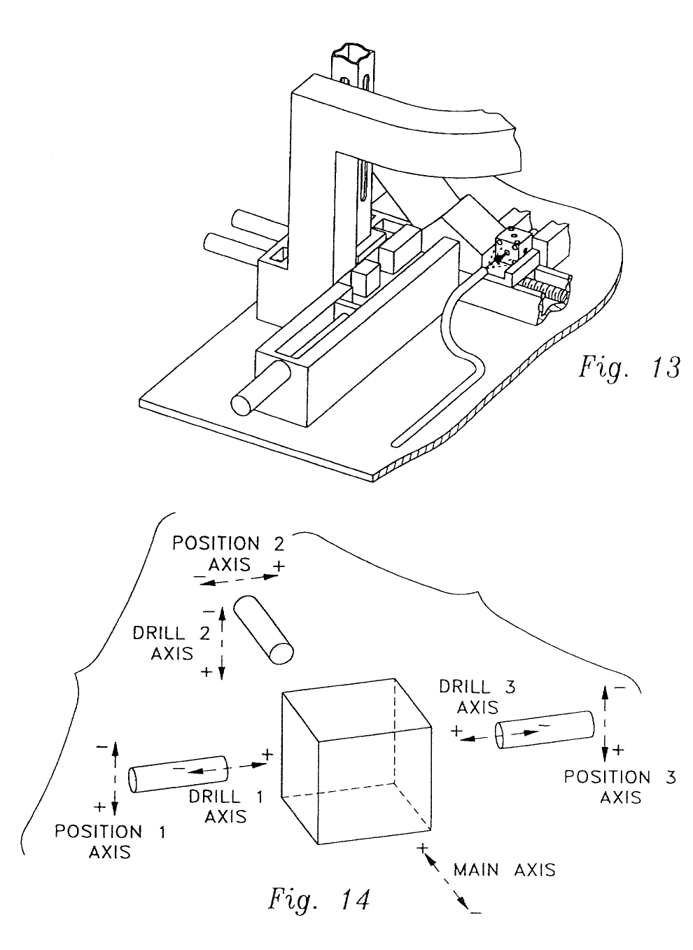

FIG. 12 shows the drill bodies executing another program to finish the work piece. FIG. 13 shows the clamp assembly extended to the exit ramp and a blast of air urges the finished work piece down the ramp and to a collection means which could be a simple container. FIG. 14 shows a detailed view of the work piece and its three drill bodies.

Obviously, numerous (additional) modifications and variations of the present invention are possible in light of the above teachings. It is, therefore, to be understood that within the scope of the appended claims, the invention may be practiced otherwise than as specifically described herein.

What is claimed is:

1. An apparatus for manufacture of dice comprising at least one cutting means, further comprising at least two axes of motion and a clamping means for holding and moving a work piece.

2. An apparatus for manufacture of dice as set forth in claim 1 wherein said clamping means moves said work piece from an input slot to an operating position and a reorientation position and an exit position.

3. An apparatus for manufacture of dice as set forth in claim 1 wherein at least one cutting means comprises two cutting means each having at least two axes of movement.

4. An apparatus for manufacture of dice as set forth in claim 1 wherein at least one cutting means comprises three cutting means each having at least two axes of movement.

5. An apparatus for manufacture of dice as set forth in claim 4 wherein each said cutting means comprise drill bits which can be moved toward and away from said work piece as well as side to side over a face thereof.

6. An apparatus for manufacture of dice as set forth in claim 1 wherein said clamping means can move about to facilitate alignment of said cutting means to drill holes in said work piece.

7. An apparatus for manufacture of dice as set forth in claim 1 further comprising a reorientation means for changing the orientation of said work piece with respect to said cutting means, thus facilitating presenting an unworked face to said cutting means.

8. An apparatus for manufacture of dice as set forth in claim 7 wherein said reorientation means comprises an arc which effects a rotation upon said work piece.

9. An apparatus for manufacture of dice as set forth in claim 7 further comprising an air charge for moving said work piece through said reorientation means.

10. An apparatus for manufacture of dice as set forth in claim 1 wherein said cutting means is computer controlled as to position of a cutting face thereof.

11. A method of cutting dice comprising the steps of feeding a work piece into a clamp means, moving said work piece from an entry chute to an operation location cutting said work piece with computer controlled cutting means, moving said work piece with respect to said cutting means to locate holes on a standard die, reorienting said work piece at least once and cutting said work piece with said cutting means at least once more.

12. An apparatus for manufacture of dice as set forth in claim 11 wherein said step of reorienting comprises moving said work piece, comprises flipping said work piece to present an uncut face of said work piece to said cutting means.

13. An apparatus for manufacture of dice as set forth in claim 12 wherein said step of reorienting further comprises applying an air blast to drive said work piece.
